(19) United States
(12) Patent Application Publication
(10) Pub. No.: US 2016/0104987 A1
(43) Pub. Date: Apr. 14, 2016

(54) ELECTRONIC SYSTEM AND COUPLING DEVICE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: WEN-HSIANG HUNG, New Taipei (TW); CHUN-BAO GU, Wuhan (CN); HUA XIAO, Wuhan (CN); HONG-MEI ZHANG, Wuhan (CN)

(21) Appl. No.: 14/526,179

(22) Filed: Oct. 28, 2014

(30) Foreign Application Priority Data
Oct. 14, 2014 (CN) 201410540665.1

(51) Int. Cl. H01R 27/02; H01R 13/502

(52) U.S. Cl. CPC H01R 27/02; H01R 13/502

(57) ABSTRACT

An electronic system includes a main control device, a display device, and a coupling device. The coupling device includes a first connector secured to the display device and a second connector secured to the main control device. The first connector has a plurality of coupling ports, the second connector has a plurality of connecting ports. The coupling ports are electronically coupled to the connecting ports, and the first connector is secured to the second connector, to secure the display device to the main control device. A coupling device used in the electronic system is further disclosed.

### FIELD

The subject matter herein generally relates to an electronic system and a coupling device in the electronic system.

### BACKGROUND

In an electronic system, a monitor is generally coupled to a main device, such as a host, via a number of cables.

### BRIEF DESCRIPTION OF THE DRAWINGS

Implementations of the present technology will now be described, by way of example only, with reference to the attached figures.

FIG. 1 is a partially exploded, isometric view of an embodiment of an electronic system.

FIG. 2 is a block diagram view of the electronic system of FIG. 1.

FIG. 3 is an assembled, isometric view of a coupling device of the electronic system of FIG. 1.

FIG. 4 is an exploded, isometric view of the coupling device of FIG. 3.

FIG. 5 is similar to FIG. 4, but viewed from a different angle.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

A definition that applies throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure describes a foot stool assembly including a foot stool, a foot pad, a grasping member, and a fastener. The foot pad includes a mounting plate. The fastener secures the mounting plate and the grasping member to the foot stool. The mounting plate is located between the foot stool and the grasping member, preventing the foot pad from coming off the foot stool.

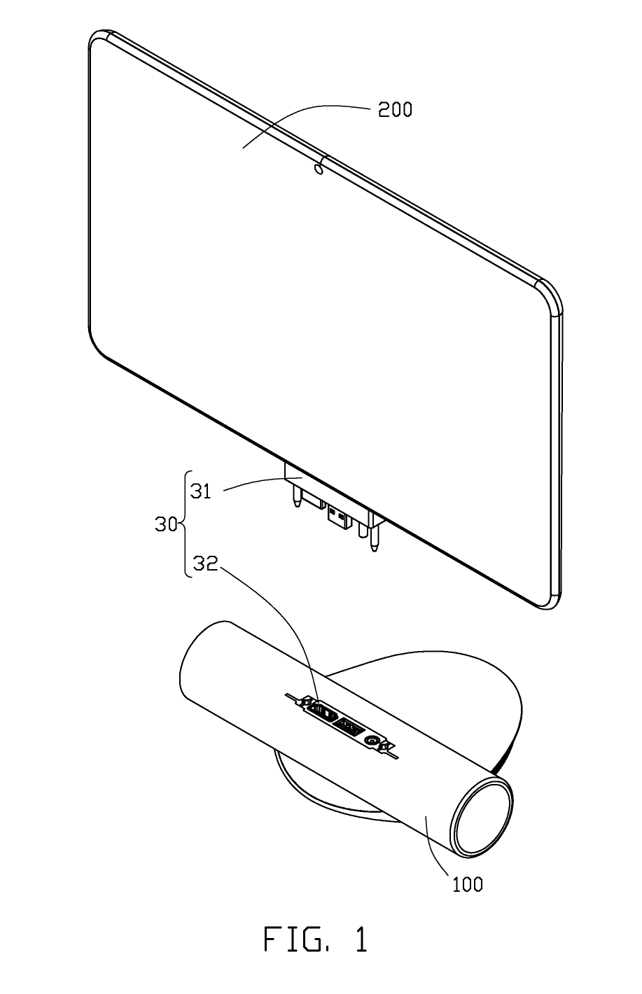

FIG. 1 illustrates an electronic system in accordance with an embodiment. The electronic system includes a main control device 100, a display device 200, and a coupling device 300 configured to couple the main control device 100 to the display device 200.

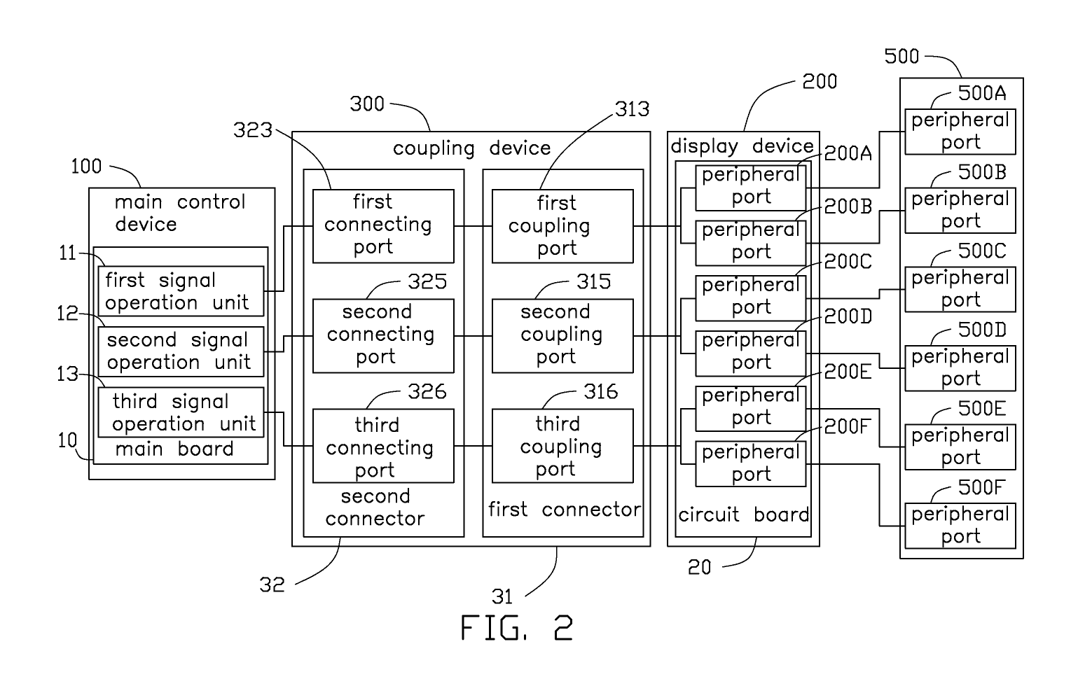

FIG. 2 illustrates that the main control device 100 includes a main board 10. A first signal operation unit 11, a second signal operation unit 12, and a third signal operation unit 13 are secured to the main board 10. In at least one embodiment, the first signal operation unit 11 is a video signal operation unit, the second signal operation unit 12 is an audio signal operation unit, and the third signal operation unit 13 is a USB signal operation unit.

The display device 200 includes a circuit board 20 and a plurality of peripheral ports 200A˜200F secured to the circuit board 20. The plurality of peripheral ports 200A˜200F are configured to couple a plurality of peripheral devices 500A˜500F. In at least one embodiment, the main control device 100 is a host, the display device 200 is a monitor or a TV, and the peripheral devices 500A˜500F can be mobile phones, tablet computers, hardware disk drives, set top boxes, speakers, mice, or keyboards.

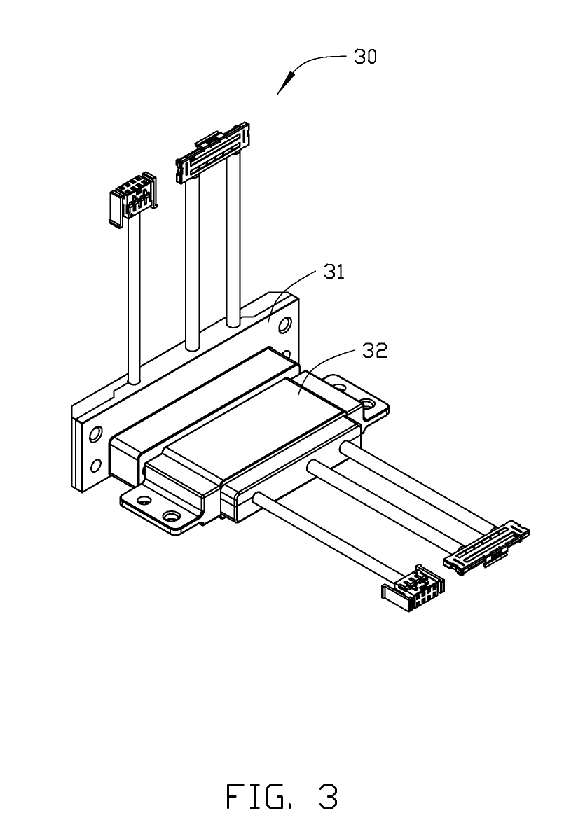

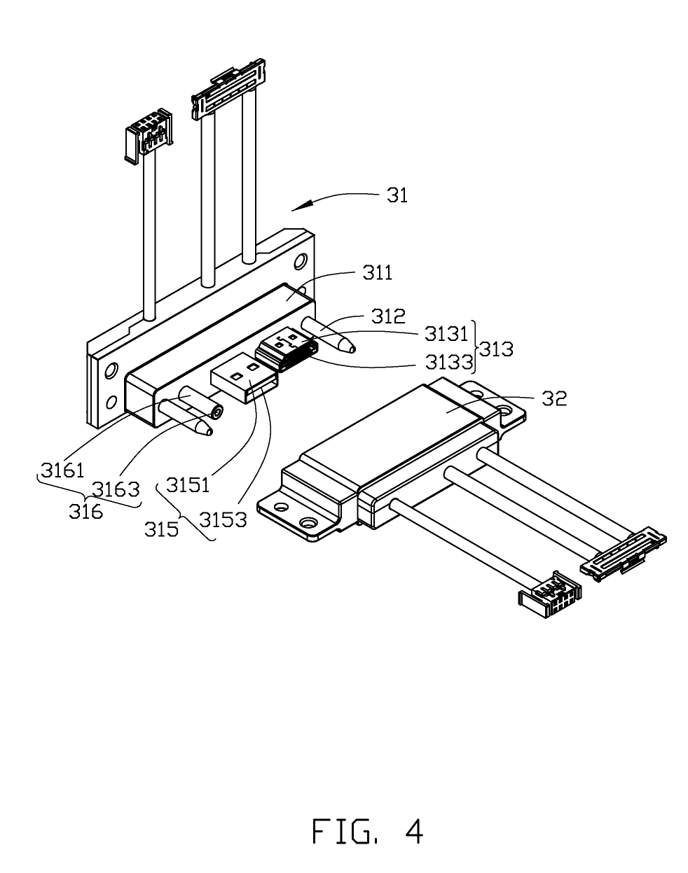

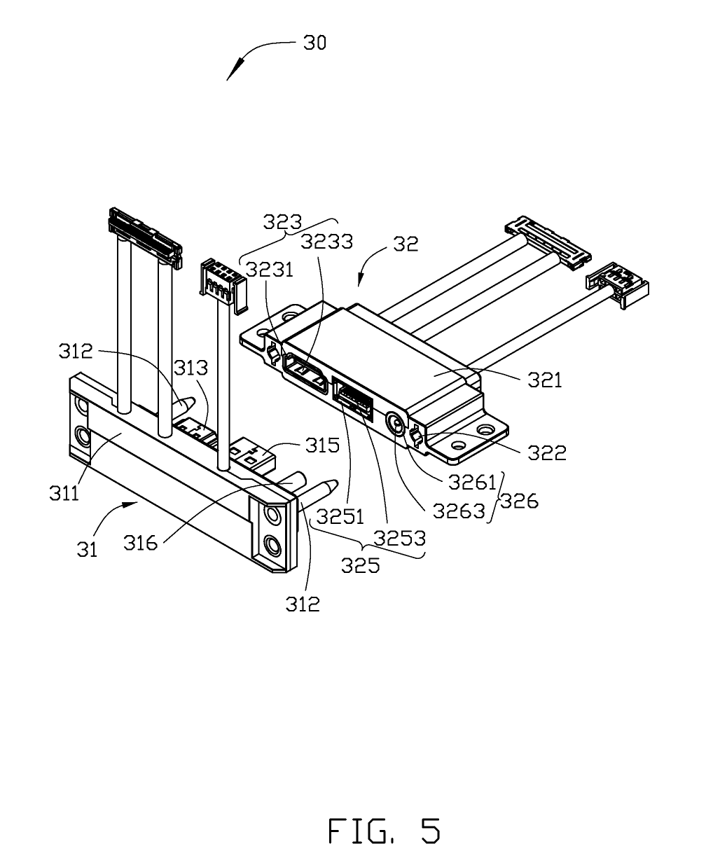

FIGS. 3-5 illustrate that the coupling device 300 includes a first connector 31 and a second connector 32. The first connector 31 includes a first base 311, two guiding posts 312 located on opposite sides of the first base 311, a first coupling port 313, a second coupling port 315, and a third coupling port 316. The first coupling port 313 includes a first case 3131 and a plurality of first coupling pieces 3133. The second coupling port 315 includes a second case 3151 and a plurality of second coupling pieces 3153. The third coupling port 316 includes a third case 3161 and a plurality of third coupling pieces 3163. In at least one embodiment, the first coupling port 313 is a HDMI port, the second coupling port 315 is an audio port, and the third coupling port 316 is a USB port.

The second connector 32 includes a second base 311 defining two guiding holes 322, a first connecting port 323, a second connecting port 325, and a third connecting port 326. The first connecting port 323 includes a first box 3231 and a plurality of first connecting pieces 3233. The second connecting port 325 includes a second box 3251 and a plurality of second connecting pieces 3253. The third connecting port 326 includes a third box 3261 and a plurality of third connecting pieces 3263. The first connecting port 323 corresponds to the first coupling port 313. The second connecting port 325 corresponds to the second coupling port 315. The third connecting port 326 corresponds to the third coupling port 316. In at least one embodiment, the first connecting port 323 is a HDMI port, the second connecting port 325 is an audio port, and the third connecting port 326 is a USB port.

In assembly, the first connector 31 is secured to the display device 200 and coupled to the circuit board 20. The first connector 31 can be secured to a bottom portion, a side portion, or a rear portion of the display device 200. The first connecting port 323 is coupled to the first signal operation unit 11. The second connecting port 325 is coupled to the second signal operation unit 12. The third connecting port 326 is coupled to the third signal operation unit 13. The second connector 32 is secured to the main control device 100 and coupled to the main board 10. The first coupling port 313 is coupled to at least one peripheral port, such as 200A and 200B. The second coupling port 315 is coupled to at least one peripheral port, such as 200C and 200D. The third coupling port 316 is coupled to at least one peripheral port, such as 200E and 200F.

The display device 200 is moved to be adjacent to the main control device 100, and the guiding posts 312 are aligned to the guiding holes 322. The display device 200 is pressed to engage the guiding posts 312 in the guiding holes 322, the first connector 31 is coupled to the second connector 32, and the display device 200 is secured to the main control device 100. The first coupling port 313 is inserted into the first connecting port 323, the second coupling port 315 is inserted into the second connecting port 325, and the third coupling port 316 is inserted into the third connecting port 326. The first case 3131 is received in the first box 3231, the second case 3151 is received in the second box 3251, and the third case 3161 is received in the third box 3261.

In at least one embodiment, the peripheral ports 200A and 200B are coupled to the peripheral devices 500A and 500B wirelessly or via cables, the peripheral devices 500A and 500B are HDMI devices; the peripheral ports 200C and 200D are coupled to the peripheral devices 500C and 500D wirelessly or via cables, the peripheral devices 500C and 500D are audio devices; the peripheral ports 200E and 200F are coupled to the peripheral devices 500E and 500F wirelessly or via cables, each of the peripheral devices 500E and 500F has a USB port.

In other embodiments, the first coupling pieces 3133, the second coupling pieces 3153, and the third coupling pieces 3163 are lined in the first base 311 directly without the first case 3131, the second case 3151, and the third case 3161. The first connecting pieces 3233, the second connecting pieces 3253, and the third connecting pieces 3263 are lined in the second base 321 directly without the first box 3231, the second box 3251, and the third box 3261.

The embodiments shown and described above are only examples. Many details are often found in the art such as the other features of an electronic system and coupling device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An electronic system comprising:
a main control device;
a display device; and
a coupling device comprising a first connector secured to the display device and a second connector secured to the main control device, the coupling device configured to releasably couple the display device to the main control device;
wherein the first connector has a plurality of coupling ports, the second connector has a plurality of connecting ports, and the coupling ports are electronically couplable to the connecting ports to secure the display device to the main control device.

2. The electronic system of claim 1, wherein the main control device comprises a plurality of signal operation units coupled to the coupling ports, the display device comprises a plurality of peripheral ports coupled to the connecting ports, each connecting port is coupled to at least one of the peripheral ports, each peripheral port is configured to couple a peripheral device.

3. The electronic system of claim 2, wherein each coupling port has a same type with the corresponding connecting port and the corresponding peripheral port, the type of each coupling port is different from other coupling ports.

4. The electronic system of claim 2, wherein each signal operation unit is configured to operate a signal transferred from corresponding coupling port, and each signal operation unit is configured to operate different signals.

5. The electronic system of claim 2, wherein the coupling ports comprises HDMI ports, USB ports, and audio ports.

6. The electronic system of claim 1, wherein the first connector further comprises a first base, and the coupling ports are located on the first base; each coupling port comprises a case and a plurality of coupling pieces located in the case; the second connector further comprises a second base, and the connecting ports are located on the second base; each connecting port comprises a box and a plurality of connecting pieces located in the box; and each case is received in the corresponding box, and the coupling pieces are coupled to the connecting pieces.

7. The electronic system of claim 6, wherein the first connector further comprises a guiding post extending from the first base, the second base defines a guiding hole, and the guiding post is engagingly received in the guiding hole.

8. An electronic system comprising:
a main control device;
a display device; and
a coupling device comprising a first connector secured to the display device and a second connector secured to the main control device;
wherein the first connector has a guiding post and a plurality of coupling ports, the second connector has a plurality of connecting ports and defines a guiding hole, the coupling ports are electronically coupled to the connecting ports, and the guiding post is engagingly received in the guiding hole, to secure the display device to the main control device.

9. The electronic system of claim 8, wherein the main control device comprises a plurality of signal operation units coupled to the coupling ports, the display device comprises a plurality of peripheral ports coupled to the connecting ports, each connecting port is coupled to at least one of the peripheral ports, each peripheral port is configured to couple a peripheral device.

10. The electronic system of claim 9, wherein each coupling port has a same type with the corresponding connecting port and the corresponding peripheral port, the type of each coupling port is different from other coupling ports.

11. The electronic system of claim 9, wherein each signal operation unit is configured to operate a signal transferred from corresponding coupling port, and each signal operation unit is configured to operate different signals.

12. The electronic system of claim 9, wherein the coupling ports are HDMI ports, USB ports, or audio ports.

13. The electronic system of claim 8, wherein the first connector further comprises a first base, and the coupling ports are located on the first base; each coupling port comprises a case and a plurality of coupling pieces located in the case; the second connector further comprises a second base, and the connecting ports are located on the second base; each connecting port comprises a box and a plurality of connecting pieces located in the box; and each case is received in the corresponding box, and the coupling pieces are coupled to the connecting pieces.

14. The electronic system of claim 13, wherein the guiding post extends from the first base, and the guiding hole is defined in the second base.

15. A coupling device comprising:
a first connector configured to be secured to a display device; and
a second connector configured to be secured to a main control device;
wherein the first connector has a plurality of coupling ports, the second connector has a plurality of connecting ports, the coupling ports are electronically coupled to the connecting ports, and the first connector is secured to the second connector, to secure the display device to the main control device.

16. The coupling device of claim 15, wherein each coupling port has a same type with the corresponding connecting port, and the type of each coupling port is different from other coupling ports.

17. The coupling device of claim 16, wherein the coupling ports comprises HDMI ports, USB ports, and audio ports.

18. The coupling device of claim 15, wherein the first connector further comprises a first base, and the coupling ports are located on the first base; each coupling port comprises a case and a plurality of coupling pieces located in the case; the second connector further comprises a second base, and the connecting ports are located on the second base; each connecting port comprises a box and a plurality of connecting pieces located in the box; and each case is received in the corresponding box, and the coupling pieces are coupled to the connecting pieces.

19. The coupling device of claim 18, wherein the first connector further comprises a guiding post extending from the first base, the second base defines a guiding hole, and the guiding post is engagingly received in the guiding hole.
